(19) United States
(12) Patent Application Publication
(10) Pub. No.: US 2012/0198751 A1
(43) Pub. Date: Aug. 9, 2012

(54) HUNTING DECOY

(76) Inventor: Jesse Zeigler, Carnation, WA (US)

(21) Appl. No.: 13/366,150

(22) Filed: Feb. 3, 2012

Related U.S. Application Data
(60) Provisional application No. 61/439,223, filed on Feb. 3, 2011.

(51) Int. Cl. A01M 31/06

(52) U.S. Cl. 43/2

(57) ABSTRACT

Disclosed in one embodiment is a hunting decoy which comprises a decoy body and a rim which defines a decoy cavity. The hunting decoy may emulate a natural water feature such as a pond or other body of standing water and include a scale image of pond or other body of standing water. Additionally, the decoy cavity may be filled with water in some embodiments to further the illusion of a pond or other body of standing water.

### BACKGROUND

Decoys can be used in the hunting of waterfowl to attract the birds to a given location. Many decoys are designed to look like or emulate a given type of waterfowl and are conventionally deployed in ponds or other bodies of water, which attracts flying waterfowl to the location and lures these birds to land in the water.

Decoys have been introduced that provide life-like movement that adds to the attraction for waterfowl. Shakers are decoys with a small electric motor and an offset weighted wheel. As the wheel turns it causes the decoy to “shake” in the water and create wave rings throughout the decoy spread. Spinning wing decoys are also fitted with an electric motor and simulate the wing beats of landing birds. Such moving or motorized decoys can be quite effective when hunting waterfowl and have been banned in some states. Therefore, there is a need in the art for effective decoys that do not move or include motorized components.

Ponds and other bodies of water are limited and many bodies of water are not accessible by hunters. Additionally, many accessible bodies of water are undesirable to waterfowl because of ice or lack of water. Therefore, waterfowl may only land in a limited number of locations, and hunters can only hunt in an even more limited number of locations. While it may be possible for a hunter to flood an area and create a body of water to attract waterfowl, such an undertaking is expensive and cumbersome, and would not be permitted on public lands. Therefore, there is a need in the art for hunting decoys that emulate ponds or other bodies of water.

### SUMMARY

Disclosed in one embodiment is a hunting decoy which comprises a decoy body and a rim which defines a decoy cavity. The hunting decoy may emulate a natural water feature such as a pond or other body of standing water and include a scale image of pond or other body of standing water. Additionally, the decoy cavity may be filled with water in some embodiments to further the illusion of a pond or other body of standing water.

One embodiment is a waterfowl hunting decoy system that includes a hunting decoy with a decoy body portion having a substantially planar sheet and a substantially contiguous rim; and a decoy cavity defined by the decoy body portion and the rim, the decoy cavity configured to hold a volume of liquid.

Another embodiment includes a method of decoying and hunting waterfowl, the method comprising: positioning a hunting decoy on the ground in an outdoor area where waterfowl may be present, the hunting decoy comprising: a decoy body portion comprising a substantially planar sheet; a substantially contiguous rim having a height greater than the decoy body when the hunting decoy is positioned on the ground; and a decoy cavity defined by the decoy body portion and the rim, the decoy cavity configured to hold a volume of liquid; and, introducing a volume of liquid to the decoy cavity such that a substantial portion of the decoy body portion is covered by the liquid.

One embodiment may further include securing the hunting decoy to the ground via one or more securing members and inflating a rim cavity by introducing a fluid into the rim cavity.

### BRIEF DESCRIPTION OF THE DRAWINGS

FIG. 1a is a top view of a hunting decoy in accordance with an embodiment.

FIG. 1b is a cross-section view of a hunting decoy in accordance with the embodiment of FIG. 1a.

FIG. 2a is a cross-section view of a hunting decoy in accordance with the embodiments of FIG. 1a and 1b, which is holding a liquid.

FIG. 2b is a cross-section view of a hunting decoy in accordance with the embodiments of FIG. 1a and 1b, further comprising a firing blind.

FIG. 3a is a top view of a hunting decoy system in accordance with an embodiment.

FIG. 3b is a cross-section view of a hunting decoy system in accordance with an embodiment.

### DETAILED DESCRIPTION

FIGS. la and lb depict a hunting decoy 100, which comprises a decoy body 110 and a rim 120 which defines a decoy cavity 130.

The decoy body 110 may comprise various suitable designs, illustrations, images or the like. For example in an embodiment, it may be desirable for various portions of the hunting decoy 100 to emulate a natural water feature such as a pond, a flooded field, flooded agricultural land, or other body of standing water. Accordingly, in an embodiment, the hunting decoy 100 may include a scale image of a pond or other body of standing water. For example, the image may be a top view of a pond, wherein plants or the bottom of the pond are viewable through the water of the pond. This may be desirable in some embodiments because when the hunting decoy 100 is lying on the ground and animals (e.g., water fowl) view the image of the pond, it may appear as though the hunting decoy 100 is actually a pond.

Images of ponds or other bodies of water may be any suitable image, and may be selected to match a geographic area or season. For example, ponds in the Northwest United States may appear substantially different than ponds in the Southeast United States in terms of aquatic vegetation and pond soil color. Additionally, such ponds may also have a different appearance in different seasons. Therefore, different images may be selected for the hunting decoy 100 to match such geographic and seasonal differences in pond appearance. In an embodiment, an image may comprise a food plot or other agricultural items that may lure or be desirable to one or more selected animal species. In some embodiments, an image may be a composite of a plurality of images, may be computer generated, or be generated from any other suitable source.

The decoy body 110 may be a planar sheet of various suitable shapes. For example, in an embodiment, the decoy body 110 may be circular, rectangular, an irregular shape, or be shaped like a body of water such as a pond. Additionally, the decoy body 110 may comprise various suitable planar sheet materials such as vinyl, rubber, cloth, a plastic, or the like. In some embodiments, it may be desirable for the decoy body 110 to be substantially water-resistant or water-proof.

In some embodiments, it may be desirable for the decoy body 110 to be transparent or translucent. For example, the decoy body 110 may be translucent such that when the hunting decoy 100 is placed on the ground, the ground is visible through the decoy body 110. Additionally, the decoy body 110 may be configured such that ground that is visible through the decoy body 110 appears to be flooded.

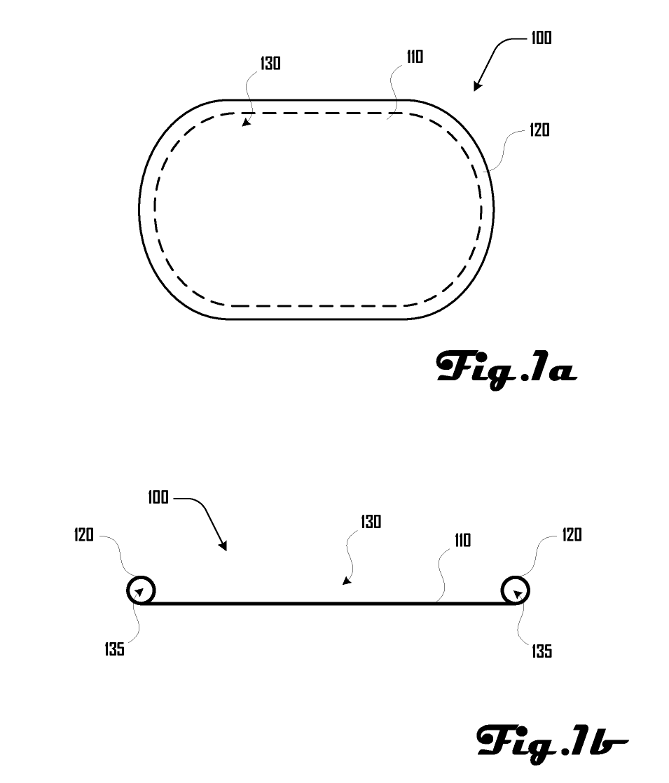

The rim 120 may be defined by a portion of the decoy body 110 which is folded and coupled upon itself to define a rim cavity 135 as shown in FIG. 1b. The rim 120 may extend around the perimeter of the decoy body 110 at a height greater than the height of the decoy body 110, which defines the decoy cavity 130.

In an embodiment, the rim cavity 135 may be filled with various suitable materials such as sand, water, air or the like. In some embodiments, the rim cavity 135 may be operable to be selectively filled with a desired material. Having a weighted material in the rim 120 may be desirable in some embodiments because such a weight may allow the hunting decoy 100 to remain substantially flat and resist movement due to forces like wind, and the like.

Additionally, in an embodiment, there may be one or more rim cavity 135, the rim cavity 135 may not be contiguous about the decoy body 110, the rim cavity may be removable, or the like. Also, although FIG. 1b depicts the rim 120 and rim cavity 135 having a circular cross-section, the rim 120 and rim cavity 135 may be any suitable shape and size in various embodiments.

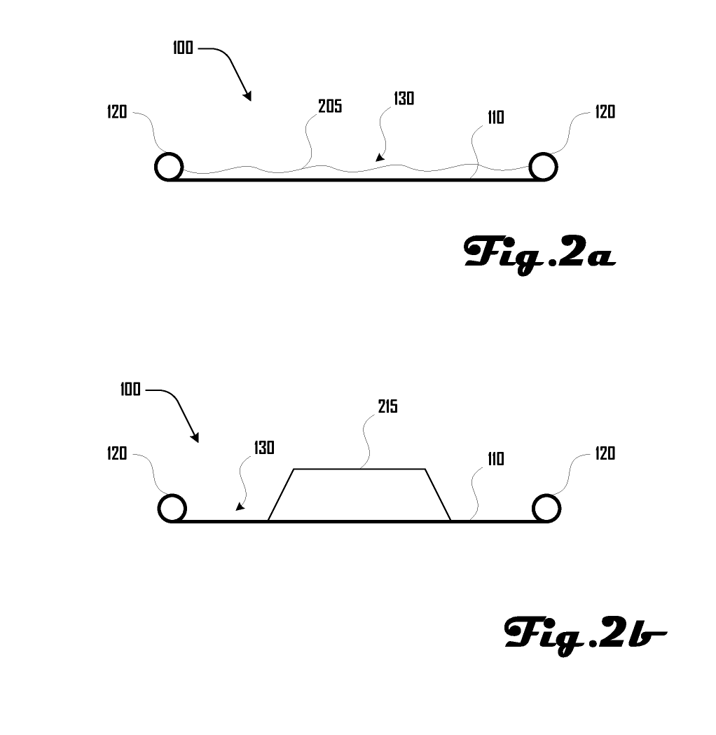

In some embodiments, as depicted in FIG. 2a for example, the decoy cavity 130 may be filled with water 205. For example, as discussed above, it may be desirable to make the surface of the decoy body 110 appear to be a pond or other body of standing water, and providing a volume of water 205 within the decoy cavity 130 may further the illusion that the hunting decoy 100 is actually a natural body of water. This illusion may be further accentuated when the decoy body 110 comprises and image of a pond or other body of water.

In some embodiments, there may be any desired volume of water 205 within the decoy cavity 130. For example, there may be a limited amount of water 205 such that only a portion of the decoy cavity 130 is filled, a limited amount of water 205 such that the volume of water 205 is only a few millimeters deep, or an amount of water 205 such that the volume of water 205 is only a few inches deep. In some embodiments, it may be desirable to include salt or other additives to the water 205 to modify the freezing point of the water 205.

In some embodiments, substances other than water 205 may be present within the decoy cavity 130. For example, water 205 may comprise particulate matter such as dirt and rock. In another example, an oil (e.g., vegetable oil) may be applied within the cavity 130. In another example, a translucent or transparent material such as a plastic or the like may be present within the decoy cavity 130, which may be present to emulate water 205.

In further embodiments, there may be any desirable objects or materials present within the decoy cavity 130, which may emulate a natural body of water. For example, there may be artificial or real plants, rocks, or the like. Additionally, there may be artificial animals present in the decoy cavity 130, including water-foul decoys.

Additionally, as depicted in FIG. 2b, objects such as a hunting blind 215 may be present within the decoy cavity 130. For example, the hunting blind 215 may be operable to cover and hide a hunter, and further provide for the hunter to fire from the blind. In some embodiments, a hunting blind 215 may be coupled to the hunting decoy 100, or may be removable therefrom. In further embodiments, the hunting blind 215 may be positioned under the decoy body 110.

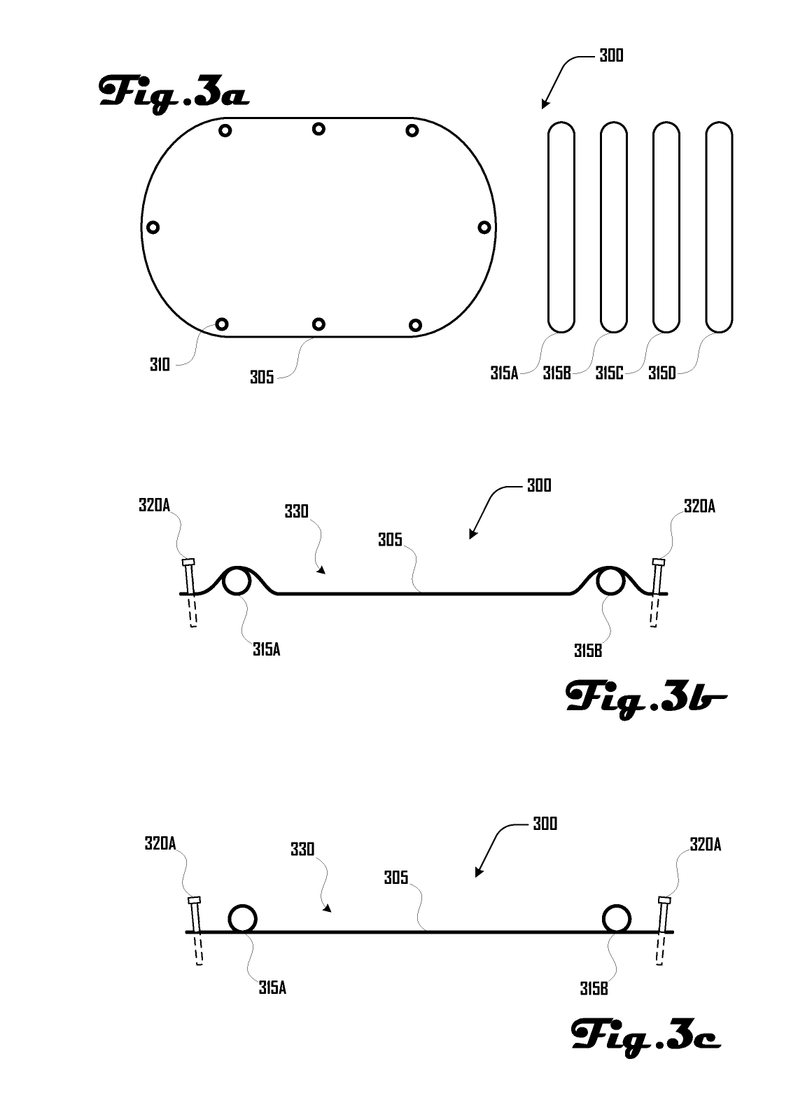

FIGS. 3a and 3b depict a hunting decoy system 300 in accordance with an embodiment. The hunting decoy system 300 comprises a decoy body 305, which includes a plurality of grommets 310 positioned about the perimeter of the decoy body 305. Additionally, the hunting decoy system 300 comprises a plurality of bags 315A-D.

As similarly described above in relation to the hunting decoy 100 depicted in FIGS. 1a, 1b, 2a and 2b, the decoy body 305 may include an image which provides for the illusion that the decoy body 305 is a pond or other body of water.

The bags 315 may be filled with various materials as discussed above in relation to the rim cavity 135. For example, the bags 315 may be filled with sand and used to secure the decoy body 305 to the ground or to define a decoy cavity 330. Referring to FIG. 3b, a first and second bag 315A, 315B may be positioned under the decoy body 305 and secured via stakes 320A, 320B that may reside within the grommets 310. The bags 315 may be positioned in any desirable configuration, which may include a position near the perimeter of the decoy body 305. Various configurations may provide for a decoy cavity 330, which may allow various materials to reside therein.

In some embodiments, a decoy body 305 may be operable to be secured to uneven ground, which may include ground which has uneven terrain, comprises objects such as rocks or stumps, or comprises vegetation or cut vegetation. For example, a decoy body 305 may be placed in a field having cut corn stalks, where the decoy body 305 resides on top of the corn stalks. In such an example, stakes of variable heights, ties on the decoy body 305, or the like, may be used to secure the decoy body 305.

In some embodiments, as depicted in FIG. 3c, bags 315A, 315B may be present on top of the decoy body 305 in a desired configuration, and stakes 320A, 320B may also be used to secure the decoy body. The bags 315A, 315B may define a decoy cavity 330.

In some embodiments, grommets 310 may be in various desired positions, and there may be any desired number of grommets 310. Additionally, in some embodiments, grommets 310 may be absent. In some embodiments, various structures may be present to provide for securing a decoy body 305 or hunting decoy 100 to a substrate such as the ground. For example, hooks, stakes 320, weights, or the like may be used for such purposes.

In some embodiments, there may be a plurality of hunting decoys 100, 300 that may be of one or more sizes and or configurations. For example, a plurality of hunting decoys 100, 300 may be setup together so that the hunting decoys 100, 300 emulate a plurality of puddles or flooded portions of a field, or the like.

In some embodiments, a hunting decoy 100, 300 may be configured to be viewed by animals walking on the ground such as turtles, rabbits, boars, or the like. For example, a hunting decoy 100, 300 having images of food plots or the like may be vertically arranged such that animals walking on the ground may view and be enticed by such an image.

In some embodiments, a hunting decoy 100, 300 may comprise a heater or heating element. For example, any desirable heating device may be present to prevent water within a hunting decoy 100, 300 from freezing, or to thaw or melt ice or snow surrounding a hunting decoy 100, 300. Such a heating device may be powered via an electrical power cord, a battery, via solar energy, or the like.

In some embodiments, a hunting decoy 100, 300 may comprise a means to generate movement of the hunting decoy 100, 300 or movement of water therein. For example, a rope or other suitable line may be connected to a portion of the hunting decoy 100, 300, or objects present therein, which allows a user to pull the line and thereby create movement.

While FIGS. 1-3 depict exemplary embodiments, various other embodiments are contemplated herein, and in some embodiments, there may be a plurality of any desired element or structure, or various structures or elements may be absent in some embodiments.

Accordingly, from the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. A method of decoying and hunting waterfowl, the method comprising:
positioning a hunting decoy on the ground in an outdoor area where waterfowl may be present, the hunting decoy comprising:
a decoy body portion comprising a substantially planar sheet;
a substantially contiguous rim having a height greater than the decoy body when the hunting decoy is positioned on the ground; and
a decoy cavity defined by the decoy body portion and the rim, the decoy cavity configured to hold a volume of liquid; and, introducing a volume of liquid to the decoy cavity such that a substantial portion of the decoy body portion is covered by the liquid.

2. The method of claim 1, wherein the decoy body portion comprises an image of, or an image configured to emulate, a natural body of standing water.

3. The method of claim 1, wherein the hunting decoy comprises one or more securing members configured to secure the hunting decoy to the ground; and wherein the method further comprises:
securing the hunting decoy to the ground via the one or more securing members.

4. The method of claim 3, wherein the one or more securing members comprises at least one of a grommet, stake, and weight.

5. The method of claim 1, wherein the rim defines a rim cavity.

6. The method of claim 5, wherein the rim cavity is configured to hold a fluid and wherein the method further comprises inflating the rim cavity by introducing a fluid into the rim cavity.

7. The method of claim 5, wherein the rim cavity holds a weight material and the rim is configured to secure the hunting decoy to the ground.

8. The method of claim 1, further comprising positioning a waterfowl decoy in the decoy cavity.

9. The method of claim 1, further comprising positioning an artificial plant or artificial rock in the decoy cavity.

10. A waterfowl hunting decoy system for emulating a natural body of water, the system comprising:
a hunting decoy comprising:
a decoy body portion comprising a substantially planar sheet;
a substantially contiguous rim; and
a decoy cavity defined by the decoy body portion and the rim, the decoy cavity configured to hold a volume of liquid.

11. The system of claim 10, wherein the decoy body portion comprises an image of, or an image configured to emulate, a natural body of standing water.

12. The system of claim 10, wherein the hunting decoy system comprises one or more securing members configured to secure the hunting decoy to the ground.

13. The system of claim 12, wherein the one or more securing members comprise at least one of a grommet, stake, and weight.

14. The system of claim 10, wherein the rim defines a rim cavity.

15. The system of claim 14, wherein the rim cavity is configured to hold a fluid.

16. The system of claim 14, wherein the rim cavity holds a weight material and the rim is configured to secure the hunting decoy to the ground.

17. The system of claim 10, further comprising waterfowl decoy.

18. The system of claim 10, further comprising an artificial plant or artificial rock.

19. The system of claim 10, further comprising a hunting blind portion.
